(19) United States
(12) Patent Application Publication
(10) Pub. No.: US 2024/0072652 A1
(43) Pub. Date: Feb. 29, 2024

(54) COMMON MODE EMI FILTER

(71) Applicant: Texas Instruments Incorporated, Dallas, TX (US)

(72) Inventors: Yogesh Ramadass, SAN JOSE, CA (US); Ashish Kumar, SANTA CLARA, CA (US)

(21) Appl. No.: 17/897,406

(22) Filed: Aug. 29, 2022

(51) Int. Cl. H02M 1/44; H02M 1/12; H02M 1/15

(52) U.S. Cl. CPC H02M 1/44; H02M 1/123; H02M 1/15

(57) ABSTRACT

Described embodiments include a circuit for filtering electromagnetic interference (EMI) that includes an electrically conductive housing enclosing the circuit, a first power terminal providing a first signal, and a second power terminal providing a second signal, the first and second signals forming a differential power input. A filter circuit provides a common mode noise cancelling signal at an output responsive to first and second inputs. An inductive choke has first and second coils that are magnetically coupled. The first coil is coupled between the first power terminal and a first converter input. The second coil is coupled between the second power terminal and a second converter input. A third capacitor is coupled between the filter output and the second power terminal. A fourth capacitor is coupled between the first power terminal and the second power terminal, and an inductor is coupled between the housing and a ground terminal.

### TECHNICAL FIELD

This description relates to power converters, and to the filtering of electromagnetic interference (EMI) in offline power converters.

### BACKGROUND

Offline power converter applications include kilowatt power converters and on-board automobile chargers having an alternating current (AC) voltage input and produce a direct current (DC) voltage output to charge a battery. These applications may include a set of relatively large inductors and capacitors to filter out EMI. Electrical circuits that are connected to an AC mains power source may be required to meet certain EMI specifications to limit the amount of electrical noise generated by the circuit from being injected onto the AC mains power line.

Electromagnetic interference (EMI) is unwanted noise or interference in an electronic device caused by electromagnetic fields generated by the operation of another electronic device. Two modes of EMI in offline power converters are differential mode EMI and common mode EMI. Common mode EMI is often a greater concern than differential mode EMI in these converters due to the larger size and cost of the components used for filtering it.

### SUMMARY

In a first example, a circuit for filtering electromagnetic interference (EMI) in a power converter includes an electrically conductive housing enclosing the circuit, a first power terminal providing a first signal, and a second power terminal providing a second signal, wherein the first and second signals form a differential power input. A filter circuit has first, second and third filter inputs, and has a filter output. The third filter input is coupled to the housing. The filter circuit is configured to provide a common mode noise cancelling signal at the filter output responsive to the first and second filter inputs.

A first capacitor is coupled between the first power terminal and the first filter input, and a second capacitor is coupled between the second power terminal and the second filter input. A voltage converter has first and second converter inputs. An inductive choke has first and second coils, the first and second coils being magnetically coupled. The first coil is coupled between the first power terminal and the first converter input. The second coil is coupled between the second power terminal and the second converter input. A third capacitor is coupled between the filter output and the second power terminal. A fourth capacitor is coupled between the first power terminal and the second power terminal, and an inductor is coupled between the housing and a ground terminal.

In a second example, a method for filtering electromagnetic interference (EMI) from a power converter includes providing a first signal from a positive terminal of a differential voltage input to a first input of a filter circuit through a first capacitor, and providing a second signal from a negative terminal of the differential voltage input to a second input of the filter circuit through a second capacitor. Using the filter circuit, a common mode noise present on the first and second signals is sensed, and a noise cancellation signal is provided at an output of the filter circuit to cancel the common mode noise;

The noise cancellation signal is added to at least one of the first signal and the second signal. A third input of the filter circuit is coupled to a housing that is electrically conductive, and the housing is connected to a ground terminal through an inductor.

In a third example, a circuit for filtering EMI includes a voltage reference terminal. A first input terminal provides a first signal, and a second input terminal provides a second signal. The first and second signals form a differential input voltage. A filter circuit has first, second and third filter inputs, and a filter output. The third filter input is coupled to the voltage reference terminal. The filter circuit is configured to provide a common mode noise cancelling signal at the filter output responsive to the first and second filter inputs.

A first capacitor is coupled between the first input terminal and the first filter input. A second capacitor is coupled between the second input terminal and the second filter input. A third capacitor is coupled between the filter output and the second input terminal. A fourth capacitor is coupled between the first input terminal and the second input terminal, and an inductor is coupled between the voltage reference terminal and a ground terminal.

### BRIEF DESCRIPTION OF THE DRAWINGS

FIG. 1 shows a block diagram of an example power converter circuit with passive EMI filtering.

FIG. 2 shows a block diagram of an example power converter circuit with active EMI filters.

FIG. 3 shows a schematic diagram for an example capacitance multiplication circuit.

FIG. 4 shows a block diagram for an example power converter circuit having an active EMI filter with a chassis-connected inductor.

FIG. 5 shows a block diagram for an example power converter circuit having an active EMI filter with a surge-protected chassis-connected inductor.

### DETAILED DESCRIPTION

In this description, the same reference numbers depict same or similar (by function and/or structure) features. The drawings are not necessarily drawn to scale.

The embodiments described herein are directed to the filtering of EMI in offline power supplies, and particularly to filters that reduce common mode EMI noise. Two example modes of EMI in offline power converters are differential mode EMI and common mode EMI. The difference between differential mode EMI and common mode EMI is the direction of the noise current on the positive and negative power lines. The positive and negative power lines can also be called line and neutral, respectively. Differential mode EMI generates a noise current that flows in opposite directions on the power supply positive and negative input terminals. In contrast, common mode EMI generates a noise current that flows in the same direction on the power supply positive line as on the power supply negative line.

EMI filters suppress switching noise generated by a power converter from being injected back onto the AC power line. A choke is an inductor that is used in specific filtering applications. A common mode choke includes two inductors that are wound on the same core. The two inductor coils on a choke are electrically isolated, but are magnetically coupled together, increasing their common mode impedance. The higher the common mode impedance of the coils of a choke, the higher noise attenuation the choke provides.

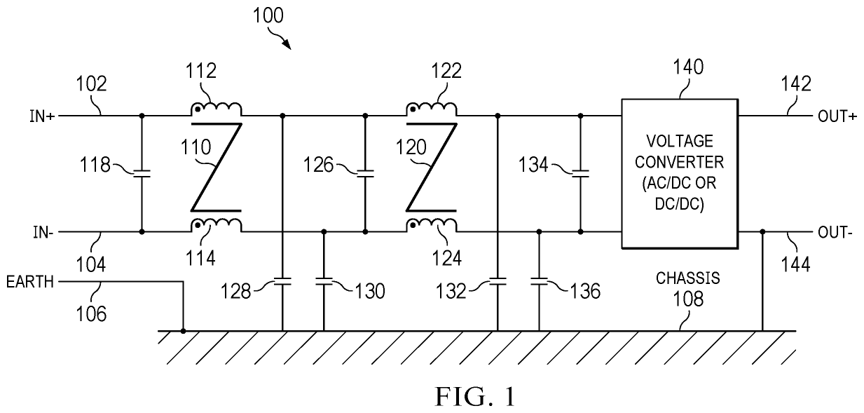

FIG. 1 shows a block diagram of an example power converter circuit 100 having passive EMI filters. The positive power input terminal for power converter circuit 100 is IN+ 102, and the negative power input terminal is IN− 104. In one example, IN+ 102 and IN− 104 is the line and neutral terminals, respectively, of the AC mains. The output of power converter circuit 100 is coupled to differential output terminals OUT+ 142 and OUT− 144. The power converter circuit has a chassis 108 that is electrically conductive. OUT− 144 is electrically connected to the chassis 108. Voltage converter 140 provides a differential regulated DC voltage across OUT+ 142 and OUT− 144. The chassis 108 is electrically connected to earth ground 106.

Power converter circuit 100 includes chokes 110 and 120. Choke 110 includes coils 112 and 114. Coil 112 is coupled to IN+ 102, and coil 114 is coupled to IN− 104. Coils 112 and 114 are magnetically coupled, but electrically isolated. Choke 120 includes coils 122 and 124. Coil 122 is coupled to a first input of voltage converter 140, and coil 124 is coupled to a second input of voltage converter 140. Coils 122 and 124 are magnetically coupled, but electrically isolated.

Capacitor 128 is coupled between coil 112 and earth ground 106. Capacitor 130 is coupled between coil 114 and earth ground 106. Capacitor 126 is coupled between coil 112 and coil 114. Capacitor 132 is coupled between coil 122 and earth ground 106. Capacitor 136 is coupled between coil 124 and earth ground 106. Capacitor 134 is coupled between the first and second inputs of voltage converter 140.

Current flows into a choke at a first coil through the terminal with a dot, and flows out of the choke at the second coil through the terminal with a dot. Current is supplied at IN+ 102 and flows through coil 112 from the terminal with a dot to the other terminal of coil 112. The current then flows into coil 122 from the terminal with a dot to the other terminal of coil 122, then into the first input of voltage converter 140. The return path for current is from the second input of voltage converter 140 into coil 124 from the terminal without a dot to the terminal with a dot. The return current then flows into coil 114 from the terminal without a dot to the terminal with a dot, then out at IN− 104. The current flows in opposite directions in the two coils of a choke. This is differential mode current, and is the main power current path. When voltage converter 140 is a switching regulator, a noise ripple current can be imposed on top of the differential mode current and also flows in opposite directions in the two coils of the choke. This noise current is differential mode EMI.

Common mode EMI is noise current that flows in the same direction in both the positive and negative power lines. Putting a choke in series with the power lines prevents currents from flowing in the same direction in the positive and negative lines due to the magnetic coupling. An ideal common mode choke would present infinite impedance to common mode current. However, in reality, chokes have a finite common mode impedance because the two coils of a choke are not perfectly coupled, resulting in a portion of the magnetic flux remaining uncoupled. This is usually called leakage flux, and can be represented in the circuit as a leakage inductance. Nonetheless, chokes 110 and 120 provide a high common mode impedance, which reduces the amount of common mode noise current. The chokes, which are used in combination with capacitors for EMI filtering, can take up a large portion of space in the EMI filtering portion of some power converter circuits.

Voltage converter 140 has chokes 110 and 120 coupled to its input terminals. A ripple current is injected into chokes 110 and 120 due to switching noise from the power transistors within voltage converter 140. This switching ripple is a major source of differential mode EMI. The noise current from common mode EMI flows in the same direction in both the positive and negative power lines. There must be a complete loop in order for current to flow. Because current flows in the same direction in the positive and negative power lines, a third terminal is required for common mode current to return. That terminal is the chassis 108, which is connected to earth ground 106. So, common mode EMI is any current flowing in the same direction through the positive and negative lines, then returning through the chassis to earth ground. Common mode EMI current does not flow in the main power current loop. Common mode EMI current flows in a noise loop that is usually caused by parasitic capacitances and inductances in the circuit.

Voltage converter 140 includes switching field effect transistors (FETs) in its output stage that carry high currents. In some cases, these switching FETs may need to be cooled down to prevent overheating, so a heatsink may be added. The heatsink is placed on top of the FET, and the heatsink is usually connected to the chassis 108, coupling the heatsink to earth ground 106. The heatsink may have a thermal interface material to ensure it is electrically isolated from the chassis 108. However, there is a parasitic capacitance between the switch node of the FETs and earth ground 106, which can be tens of picofarads.

The parasitic capacitance between the switch node of the FETs and earth ground 106 can create a problem. When the voltage at the switch node is swinging, noise is injected from the switch node onto the earth ground 106 through the parasitic capacitance. If the switch node is swinging 400-600V, amperes of current can flow through this parasitic capacitance, depending on how fast the switch node voltage is swinging. This current produces common mode EMI, which is injected into the chassis 108, and therefore onto the earth ground 106. The common mode EMI current flows through the chassis, and can be coupled back to the positive and negative input lines and injected into the AC mains power grid if the EMI left unfiltered.

Both common mode EMI and differential mode EMI can be filtered using multi-stage inductor-capacitor (L-C) filters. The capacitance in differential mode filters is often relatively large (i.e. uF), allowing the filter inductance to be relatively small (i.e. uH) while still obtaining a specified filter corner frequency. The relatively small amount of inductance needed to obtain the necessary filter characteristics can be obtained from the leakage inductance of a common mode choke. For common mode filters, the capacitance is limited to nanofarads by leakage current requirements, so the inductance needs to be larger (mH) to obtain the same filter corner frequency.

The multi-stage differential mode filter includes the leakage inductances from coils 112, 114, 122 and 124, and the capacitance from capacitors 118, 126 and 134. The multi-stage common mode filter includes the common mode inductances from coils 112, 114, 122 and 124, and the capacitance from capacitors 128, 130, 132 and 136.

A common mode filter provides no impedance for differential mode noise. The common mode filter cannot filter differential mode noise because all the current that flows into the dot terminal of the first coil of a choke is constrained to flow out of the dot terminal in the second coil of that choke. However, the non-ideal part of the common mode choke, which is the leakage inductance, provides some impedance to differential mode currents because there is no coupling of the inductance between the coils. So, leakage inductance together with the capacitor form an L-C differential mode filter.

The voltage at the switch node of voltage converter 140 can switch up and down hundreds of volts, injecting common mode noise into the chassis 108. This noise is filtered by capacitors 128, 130, 132 and 136. The majority of this noise is filtered by capacitors 136 and 132. A proportionally less amount of this noise is then filtered by capacitors 130 and 128. The capacitors provide a low impedance path for noise to get back to the input, and the common mode chokes provide a high impedance in series to reduce the amount of noise flowing through the input terminals.

Capacitors of hundreds of nF to a few uF can be used in differential mode filters. Using a larger capacitor allows use of a smaller inductor to obtain the same filter corner frequency. In one example, a 1 uH inductance is used in combination with a 1 uF capacitor to achieve the specified filter corner frequency. For this reason, the leakage inductances of chokes 110 and 120 provide enough inductance, so separate inductors are not needed for the differential mode filter.

A large capacitor cannot be used in a common mode filter due to a potential safety problem. If the chassis 108 gets disconnected from earth ground 106, and a person standing on earth ground touches the chassis, the person is now coupled between the capacitor and earth ground. As that capacitance increases, the impedance between the AC voltage source and earth ground decreases. As the impedance between the AC voltage source and earth ground decreases, the amount of current supplied by the capacitor that can flow through the person increases, creating a safety concern.

To alleviate this safety concern, capacitors 128, 130, 132 and 136 may be in the range of 1-10 nF. If a capacitor having a couple orders of magnitude lower capacitance is used, an inductance of a couple orders of magnitude higher would be required to obtain the same filter corner frequency. This is why the common mode inductor ends up being relatively large, for example a few mH, leading to physically large chokes being used in the circuit.

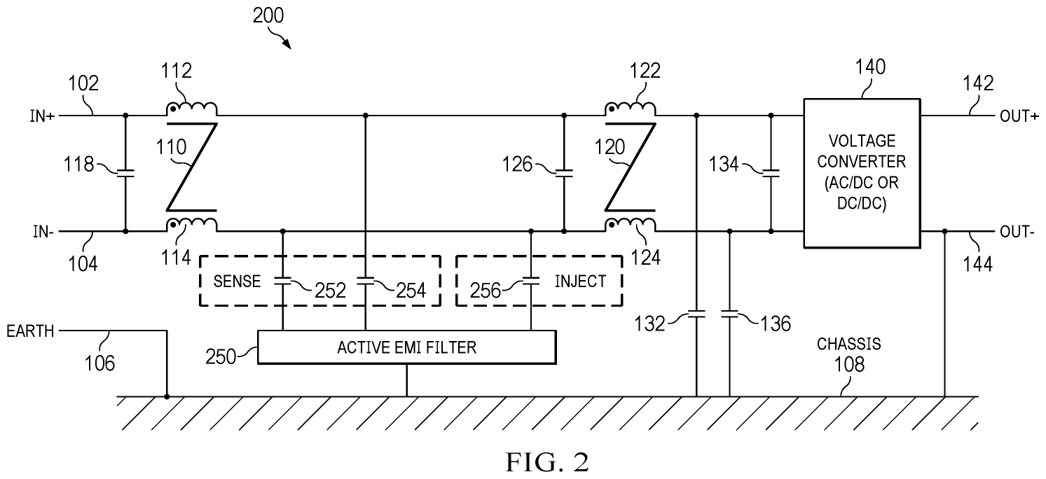

FIG. 2 shows a block diagram of an example power converter circuit 200 with active EMI filtering. In power converter circuit 200, capacitors 128, 130, 132 and 136 of power converter circuit 100 effectively have a larger capacitance by using a capacitance multiplication circuit, which can also be known as capacitance amplification.

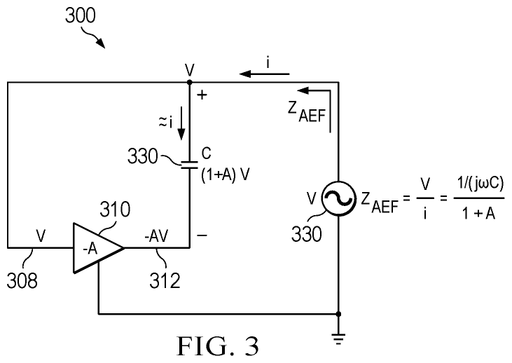

FIG. 3 shows a schematic diagram for an example capacitance multiplication circuit 300. A voltage source 330 provides a voltage V. Amplifier 310 has an input 308 that is coupled to voltage source 330, and receives the voltage V at its input. Amplifier 310 inverts and amplifies the voltage V by a gain A, where A is positive and is greater than one. The voltage at the output 312 of amplifier 310 is equal to −AV. Capacitor 320 has a first terminal coupled to the input of amplifier 310, which is at voltage V, and has a second terminal coupled to the output of amplifier 310, which is at a voltage of AV. The voltage across capacitor 320 is (1+A)V.

The voltage V at the first terminal of capacitor 320 is sensed. The sensed voltage V is provided as an input to amplifier 310 to be amplified and inverted. The output of the amplifier has a voltage −AV, which is provided to the second terminal of capacitor 320. The voltage across capacitor 320 is now (1+A) times the original voltage across the capacitor, which decreases the impedance of the circuit by a factor of (1+A). Hence, the capacitor impedance looks like a smaller impedance, or effectively a larger capacitance, by providing amplification and inversion of a voltage at a first capacitor terminal, then injecting the amplified and inverted signal into the second capacitor terminal.

A first advantage that capacitance multiplication circuit 300 provides is that it produces a larger effective capacitance. Using a smaller capacitor, but effectively making it a larger capacitance in the circuit, allows a proportionally smaller inductor to be used while still maintaining the same filter corner frequency and effectiveness.

A second advantage that capacitance multiplication circuit 300 provides is that the frequencies at which the capacitor produces an effectively larger capacitance can be selected by the transfer function of the amplifier. By placing resistors and capacitors in either the feedback loop or the input circuit path of amplifier 310, the frequency response of the amplifier can be shaped. At low frequencies (e.g. 50-60 Hz) where a higher voltage from the positive power input signal is, the amplifier can provide a relatively small gain. This allows the capacitor to present a small effective capacitance at low frequencies, preventing violation of the restriction against having a large capacitance between earth ground and a current-carrying line. But at higher frequencies (e.g tens of KHz), the gain can be increased so that the capacitor has a larger effective capacitance. EMI is usually measured in circuits at frequencies higher than 150 KHz, so a large effective capacitance at those frequencies improves that measurement. If the effective capacitance is 100× larger at a given frequency, the inductor can be 100× smaller and achieve the same corner frequency and EMI filter characteristic.

The positive power input terminal for power converter circuit 200 is IN+ 102, and the negative power input terminal is IN− 104. The output of power converter circuit 200 is coupled to differential output terminals OUT+ 142 and OUT− 144. The power converter circuit has a chassis 108 that is electrically conductive. OUT− 144 is electrically connected to the chassis 108, which provides a reference voltage. Voltage converter 140 provides a differential regulated DC voltage across OUT+ 142 and OUT− 144. The chassis 108 is electrically connected to earth ground 106.

Power converter circuit 200 includes chokes 110 and 120. Choke 110 includes coils 112 and 114. Coil 112 is coupled to IN+ 102, and coil 114 is coupled to IN− 104. Coils 112 and 114 are magnetically coupled. Choke 120 includes coils 122 and 124. Coil 122 is coupled to a first input of voltage converter 140, and coil 124 is coupled to a second input of voltage converter 140. Coils 122 and 124 are magnetically coupled.

Capacitor 118 is coupled between IN+ 102 and IN− 104. Capacitor 126 is coupled between coil 112 and coil 114. Capacitor 132 is coupled between coil 122 and earth ground 106. Capacitor 136 is coupled between coil 124 and earth ground 106. Capacitor 134 is coupled between the first and second inputs of voltage converter 140. Capacitor 252 is coupled between coil 114 and a first input of active EMI filter 250. Capacitor 254 is coupled between coil 112 and a second input of active EMI filter 250. Capacitor 256 is coupled between coil 114 and an output of active EMI filter 250. A third input of active EMI filter 250 is coupled to the chassis 108. Capacitors 252 and 254 are sensing the voltages on the IN+ and IN− lines, respectively, and capacitor 256 injects a noise cancellation signal onto the IN− line.

In some cases, an additional capacitor (not shown) is coupled between coil 112 and a second output (not shown) of active EMI filter 250 to inject a signal onto the IN+ line. However, in other cases, the additional capacitor between coil 112 and the second output of active EMI filter 250 is not required as long as the capacitance of capacitor 126 is sufficiently large. In this case, capacitor 126 couples the injected current from the output of active EMI filter 250 from the IN− line to the IN+ line, allowing a common mode injection without the need for an additional capacitor.

Active EMI filter 250 is a filter circuit that reduces common mode EMI noise. Active EMI filter 250 has either one or two outputs and two inputs. Active EMI filter 250 is configured to receive a first AC voltage having a switching frequency at a first input, the first input being coupled to capacitor 252. Active EMI filter 250 is configured to receive at the second input a second AC voltage having the same switching frequency, the second input being coupled to capacitor 254. Active EMI filter 250 senses noise having a second frequency on at least one of the first or second inputs, and generates an injection signal at its output responsive to the detected noise. The output of active EMI filter 250 is coupled to at least one of the IN+ and IN− lines. An example implementation of an Active EMI filter is described in U.S. patent application Ser. No. 17/223,835 filed Apr. 6, 2021, which is incorporated herein by reference in its entirety.

Active EMI filter 250 has first and second inputs coupled to capacitors 252 and 254 for sensing common mode noise, and has an output coupled to capacitor 256 for injecting an inverted amplified noise cancellation signal into the IN+ and IN− signal paths. In some examples, an additional injection capacitor is coupled between a second output of active EMI filter 250 and coil 112. In other examples, where capacitor 126 is sufficiently large, the additional inject capacitor may be omitted. The inject capacitors are the capacitances being amplified within active EMI filter 250. Capacitors 254 and 252 capacitively sense noise on the IN+ and IN− lines, respectively, to avoid directly coupling a high voltage terminal to the input terminals of active EMI filter 250.

The common mode noise current enters power converter circuit 200 at the IN+ 102 and IN− 104 terminals. The common mode noise current flows from the IN+ 102 and IN− 104 terminals through coils 112 and 114, respectively, flowing from the terminal having a dot to the terminal not having a dot of coil 112 and coil 114, respectively. Common mode noise current flows in the same direction in coil 112 as it flows in coil 114.

The common mode noise current from coil 112 flows through capacitor 254, then into the second input of active EMI filter 250. The common mode noise current from coil 114 flows through capacitor 252, then into the first input of active EMI filter 250. The common mode noise current that is not filtered by the AEF flows into the chassis 108, then into the earth ground 106. A portion of the common mode noise current then makes its way back onto the IN+ and IN− lines.

Noise is produced by the switching of FETs that are within voltage converter 140. This noise can be injected into the chassis 108 through parasitic capacitances. Active EMI filter 250 senses the noise current on the IN+ and IN− lines through capacitors 254 and 252, respectively. Active EMI filter 250 extracts the high frequency common mode component of the noise current, while rejecting the line-frequency and differential mode components of the signal. The common mode noise component is amplified and inverted. The amplified and inverted signal is then injected onto the IN− line through capacitor 256, and onto the IN+ line through capacitors 256 and 126.

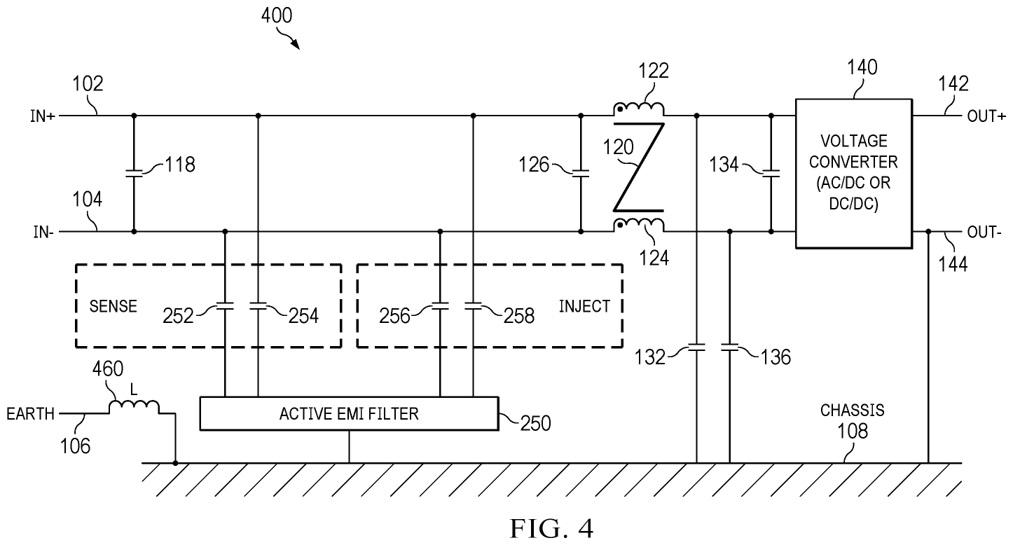

FIG. 4 shows a block diagram for an example power converter circuit 400 having an active EMI filter with a chassis-connected inductor. Power converter circuit 400 does not have a choke in series with the IN+ line or the IN− line. The two chokes in the IN+ and IN− line of power converter circuit 200 have been replaced with an inductor coupled between the chassis 108 and earth ground 106. Capacitor 254 is directly coupled to the IN+ terminal 102 instead of being coupled through a choke coil. Capacitor 252 is directly coupled to the IN− terminal 104 instead of being coupled through a choke coil. The other terminals of capacitors 252 and 254 are coupled to the first and second inputs, respectively, of active EMI filter 250.

Common mode noise current enters power converter circuit 400 at the IN+ 102 and IN− 104 terminals. The common mode noise current from IN+ 102 flows through capacitor 258. The common mode noise current from IN− 104 flows through capacitor 256. The common mode noise current that is filtered by the AEF, then flows into the chassis 108. Inductor 460 is coupled between the chassis 108 and earth ground 106.

Because inductor 460 is coupled in series between the chassis 108 and earth ground 106, the same common mode noise current that flows through the IN+ and IN− lines flows through the earth ground, and then back to the inputs of active EMI filter 250. If the inductance of inductor 460 is the same as the inductance of coils 112 and 114, power converter circuit 400 will have the same series circuit impedance, and the same amount of current will flow in the circuit. However, the difference is that inductor 460 does not carry the large power current that coils 112 and 114 carried, but instead carries a smaller common mode current. Therefore, inductor 460 can be smaller than either coil 112 or 114 because it carries a smaller current.

Power converter circuit 400 provides at least two advantages. A first advantage is that two inductors are replaced by a single inductor, because coils 112 and 114 are replaced by inductor 460. A second advantage is that the single inductor is considerably smaller than either of the two inductors it replaces because it carries a smaller current. Also, because the wire gauge of inductor 460 is smaller than coils 112 and 114, the core of the inductor can be smaller than the choke core.

The common mode noise current through inductor 460 may be in the range of a few mA to hundreds of mA. Whereas, the power current through IN+ and IN− may be hundreds of amps. So, the coils that are required to handle hundreds of amps of current are replaced with an inductor that is only required to handle hundreds of mA. The common mode path inductance is the same, but now the inductor is handling three orders of magnitude less current, making the physical size of the inductor smaller, which saves space and cost.

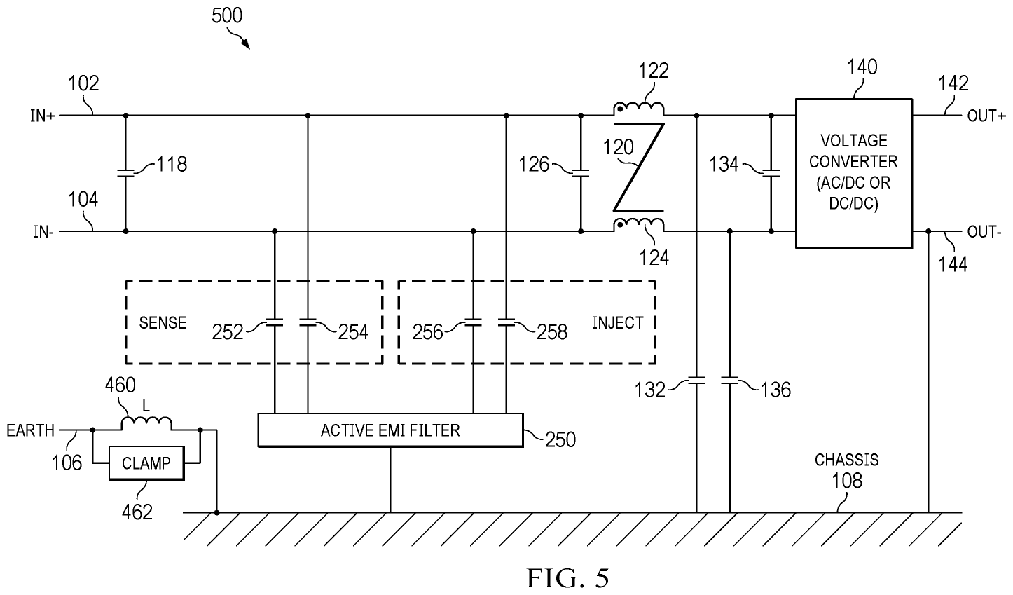

FIG. 5 shows a block diagram for an example power converter circuit 500 having an active EMI filter with a surge-protected chassis-connected inductor. Power converter circuit 500 is identical to power converter circuit 400 except that a clamp 462 is added in parallel with inductor 460 for surge suppression. Although inductor 460 usually handles only small currents, a surge event can occur, either coming from earth ground 106 or from the chassis 108. Inductor 460 could be damaged by such a surge event if it is not protected. Clamp 462 is coupled in parallel with inductor 460 to provide protection from a surge event. Clamp 462 can be a transient voltage suppression (TVS) diode or some other type of circuit that is designed to limit a voltage to a certain level. Clamp 462 protects inductor 460 against electrical overstresses, such as those induced by lightning strikes, inductive load switching, and electro-static discharge.

In this description, “terminal,” “node,” “interconnection,” “lead” and “pin” are used interchangeably. Unless specifically stated to the contrary, these terms generally mean an interconnection between or a terminus of a device element, a circuit element, an integrated circuit, a device, or other electronics or semiconductor component.

In this description, “ground” includes a chassis ground, an Earth ground, a floating ground, a virtual ground, a digital ground, a common ground and/or any other form of ground connection applicable to, or suitable for, the teachings of this description.

In this description, even if operations are described in a particular order, some operations may be optional, and the operations are not necessarily required to be performed in that particular order to achieve specified results. In some examples, multitasking and parallel processing may be advantageous. Moreover, a separation of various system components in the embodiments described above does not necessarily require such separation in all embodiments.

Modifications are possible in the described embodiments, and other embodiments are possible, within the scope of the claims.

What is claimed is:

1. A circuit for filtering electromagnetic interference (EMI) in a power converter, the circuit comprising:
a housing that is electrically conductive, the housing enclosing the circuit;
a first power terminal providing a first signal, and a second power terminal providing a second signal, the first and second signals forming a differential power input;
a filter circuit having first, second and third filter inputs, and having a filter output, the third filter input coupled to the housing, the filter circuit configured to provide a common mode noise cancelling signal at the filter output responsive to the first and second filter inputs;
a first capacitor coupled between the first power terminal and the first filter input;
a second capacitor coupled between the second power terminal and the second filter input;
a voltage converter having first and second converter inputs;
an inductive choke having first and second coils, the first and second coils magnetically coupled, the first coil coupled between the first power terminal and the first converter input, and the second coil coupled between the second power terminal and the second converter input;
a third capacitor coupled between the filter output and the second power terminal;
a fourth capacitor coupled between the first power terminal and the second power terminal; and
an inductor coupled between the housing and a ground terminal.

2. The circuit of claim 1, wherein the filter output is a first filter output, the filter circuit includes a second filter output, and the circuit further comprises a fifth capacitor coupled between the second filter output and the first power terminal.

3. The circuit of claim 1, further comprising:
a fifth capacitor coupled between the first converter input and the housing; and
a sixth capacitor coupled between the second converter input and the housing.

4. The circuit of claim 1, wherein the circuit further comprises a clamp circuit connected in parallel with the inductor, the clamp circuit configured to provide protection from a voltage surge to the circuit.

5. The circuit of claim 4, wherein the clamp circuit includes a transient voltage suppression (TVS) diode.

6. The circuit of claim 1, further comprising a fifth capacitor coupled between the first and second converter inputs.

7. The circuit of claim 1, wherein the filter circuit includes a capacitance multiplication circuit.

8. The circuit of claim 7, wherein the capacitance multiplication circuit includes:
an amplifier having an amplifier input and an amplifier output, the amplifier input coupled to a voltage source terminal; and
a fifth capacitor coupled between the amplifier input and the amplifier output.

9. The circuit of claim 8, wherein a gain of the amplifier varies as a function of a frequency of a signal at the voltage source terminal.

10. A method for filtering electromagnetic interference (EMI) from a power converter, the method comprising:
providing a first signal from a positive terminal of a differential voltage input to a first input of a filter circuit through a first capacitor;
providing a second signal from a negative terminal of the differential voltage input to a second input of the filter circuit through a second capacitor;
using the filter circuit, sensing a common mode noise present on the first and second signals, and providing a noise cancellation signal at an output of the filter circuit to cancel the common mode noise;
adding the noise cancellation signal to at least one of the first signal and the second signal;
coupling a third input of the filter circuit to a housing that is electrically conductive; and
connecting the housing to a ground terminal through an inductor.

11. The method of claim 10, further comprising providing surge event protection by connecting a voltage clamp circuit in parallel with the inductor.

12. The method of claim 11, wherein the voltage clamp circuit includes a transient voltage suppression (TVS) diode.

13. The method of claim 10, further comprising:
providing the first signal to a first terminal of a differential converter input of a voltage converter through a first inductive coil; and
providing the second signal to a second terminal of the differential converter input through a second inductive coil, the second inductive coil being magnetically coupled to the first inductive coil.

14. The method of claim 13, further comprising:
coupling a third capacitor between a first terminal of the first inductive coil and a first terminal of the second inductive coil; and
coupling a fourth capacitor between a second terminal of the first inductive coil and a second terminal of the second inductive coil.

15. The method of claim 10, further comprising:
providing a second noise cancellation signal at a second output of the filter circuit; and
adding the second noise cancellation signal to a second one of the first signal and the second signal.

16. A circuit for filtering electromagnetic interference (EMI), the circuit comprising:
a voltage reference terminal;
a first input terminal providing a first signal, and a second input terminal providing a second signal, the first and second signals forming a differential input voltage;
a filter circuit having first, second and third filter inputs, and having a filter output, the third filter input being coupled to the voltage reference terminal, the filter circuit configured to provide a common mode noise cancelling signal at the filter output responsive to the first and second filter inputs;
a first capacitor coupled between the first input terminal and the first filter input;
a second capacitor coupled between the second input terminal and the second filter input;
a third capacitor coupled between the filter output and the second input terminal;
a fourth capacitor coupled between the first input terminal and the second input terminal; and
an inductor coupled between the voltage reference terminal and a ground terminal.

17. The circuit of claim 16, wherein the filter output is a first filter output, the filter circuit includes a second filter output, and the circuit further comprises a fifth capacitor coupled between the second filter output and the first input terminal.

18. The circuit of claim 16, wherein the circuit further comprises a clamp circuit connected in parallel with the inductor, the clamp circuit configured to provide protection from a voltage surge to the circuit.

19. The circuit of claim 18, wherein the clamp circuit includes a transient voltage suppression (TVS) diode.

20. The circuit of claim 16, wherein the filter circuit includes a capacitance multiplication circuit.

21. The circuit of claim 20, wherein the capacitance multiplication circuit includes:
an amplifier having an amplifier input and an amplifier output, the amplifier input coupled to a voltage source terminal; and
a fifth capacitor coupled between the amplifier input and the amplifier output.
